(19) United States
(12) Patent Application Publication
(10) Pub. No.: US 2016/0158907 A1
(43) Pub. Date: Jun. 9, 2016

(54) Wheel Rim Processing Machine

(71) Applicant: Factory Automation Technology CO.,LTD., Chiayi County (TW)

(72) Inventors: PO CHENG SU, Chiayi County (TW); YUNG HO HSIAO, Chiayi County (TW); HSIN HONG HOU, Chiayi County (TW)

(21) Appl. No.: 14/961,795

(22) Filed: Dec. 7, 2015

(30) Foreign Application Priority Data
Dec. 5, 2014 (TW) 103221705

(51) Int. Cl. B23Q 39/04; B23Q 7/14; B23B 41/00

(52) U.S. Cl. CPC B23Q 39/04; B23B 41/00; B23Q 7/1405; B23B 2215/08

(57) ABSTRACT

A wheel rim processing machine for processing a wheel rim blank into a finished product of a defined wheel rim, comprises an infeed device, a detecting device, a first processing device, a second processing device, a third processing device, a discharge device, a movable clamp device, and a controlling device, wherein the controlling device can control actuations of each of the devices; as the controlling device received detection signal sent from the detecting device, the controlling device is able to control the first processing device, the second processing device, and the third processing device to conduct particular processes corresponding to the detection signal received from the wheel rim blank.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a wheel rim processing machine and, in particular, to a wheel rim processing machine which is able to detect the size and shape of a wheel rim blank for applying corresponding processing conditions.

2. Description of Related Arts

A regular wheel rim processing machine often has more than one processing units based on its processing procedures, wherein actuations of each of the processing units are controlled by a controlling unit, so as to respectively conduct the processing procedures of establishing the inside diameter, outside diameter, side, and boring to the wheel rim blank. However, the machine can only process wheel rim blanks of a single specification during a processing process; that is to say, an operating personnel has to set up the processing conditions of a wheel rim of a single specification on the controlling unit before processing and has to reset the processing conditions every time if there will be a different wheel rim blank being processed, which delays operations resulting in fewer wheel rims being processed from wheel rim blanks.

### SUMMARY OF THE PRESENT INVENTION

Therefore, an object of the present invention is to provide a wheel rim processing machine with more convenience for producing wheel rims from wheel rim blanks.

Accordingly, the present wheel rim processing machine is for processing a wheel rim blank to produce a finished product of a defined wheel rim, and comprises an infeed device, a detecting device, a first processing device, a second processing device, a third processing device, a discharge device, a movable clamp device, and a controlling device; the infeed device is to transport the wheel rim blank to a clamping position; the detecting device is to detect the size and shape of the wheel rim blank at the clamping position and send a corresponding detection signal; the first processing device is to process the top radial size of the wheel rim blank; the second processing device is to conduct a side boring process to the wheel rim blank; the third processing device is to process the bottom radial size and the side of the wheel rim blank, so as to make the wheel rim blank into a finished product of a defined wheel rim; the discharge device is to send out finished product of a defined wheel rim; the movable clamp device is to sequentially clamp and move the wheel rim blank at the clamping position to the first processing device, the second processing device, and the third processing device, then clamp and move the finished product of the defined wheel rim after processing by the third processing device to the discharge device; and the controlling device respectively electrically connects to the infeed device, the detecting device, the first processing device, the second processing device, the third processing device, the discharge device, and the movable clamp device, so as to control the actuations of each device.

Once the controlling device receives the detection signal sent by the detecting device, the controlling device can automatically control the first processing device, the second processing device, and the third processing device to conduct specific processes, according to the detection signal, to the wheel rim blank, so as to allow the wheel rim processing machine to more efficiently process the wheel rim blank to the defined wheel rim.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of the wheel rim processing machine according to a preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

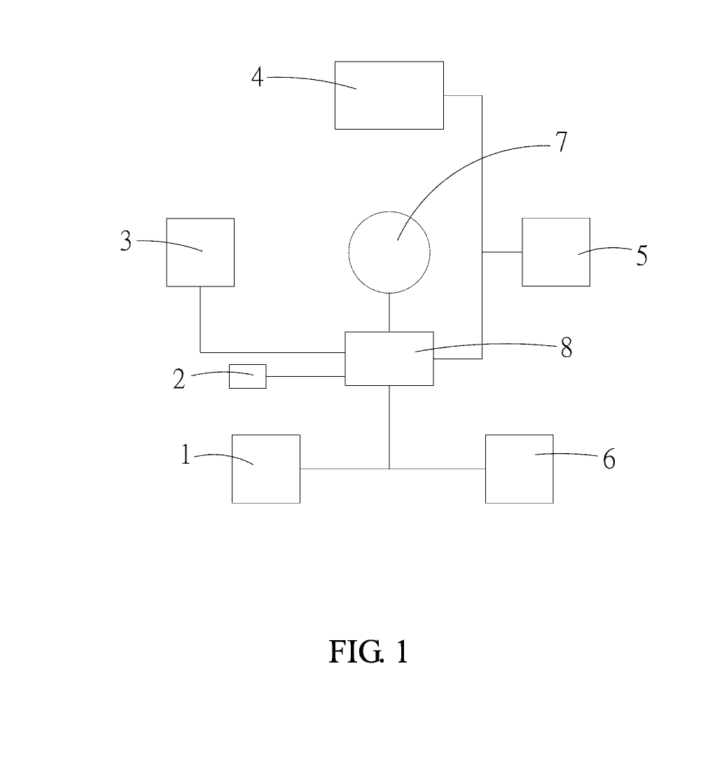

Referring to FIG. 1, the wheel rim processing machine according to a preferred embodiment of the present invention is for processing a wheel rim blank into a finished product of a defined wheel rim, and comprises an infeed device 1, a detecting device 2, a first processing device 3, a second processing device 4, a third processing device 5, a discharge device 6, a movable clamp device 7, and a controlling device 8.

The infeed device 1 can be a delivery passage arranged by many wheels; as a wheel rim blank is put thereon, the infeed device 1 can deliver the wheel rim blank to a clamping position.

The detecting device 2 detects the size and shape of the wheel rim blank located at the clamping position with light sensoring, and sends out a corresponding detection signal; that is, the detecting device 2 will send out a different detection signal as it detects a wheel rim blank with a different size or shape.

The first processing device 3 is mainly to process the radial dimension of a top portion of a wheel rim blank, which is to respectively proceed to apply cutting processes to the inside diameter and outside diameter of the wheel rim blank, so as to make the inside diameter and outside diameter of the wheel rim blank conform to the dimensional requirements.

The second processing device 4 is mainly to proceed to apply a boring process to a wheel rim blank. The side of a wheel rim blank is usually designed for a plurality of perforations for the wheel rim to be locked onto the frame of a vehicle, so the second processing device 4 is there to proceed to apply a boring process to the side of a wheel rim blank for processing at least one perforation through the wheel rim blank.

The third processing device 5 is to process the radial dimension of the bottom portion and the side of a wheel rim blank, which is to proceed to apply a cutting process to the radial dimension of the bottom portion and the side of a wheel rim blank, so as to make the wheel rim blank to conform to the dimensional requirements and process the wheel rim blank into a finished product of a defined wheel rim.

The discharge device 6 can be a delivery passage arranged by many wheels; as a finished product of a defined wheel rim is put thereon, the discharge device 6 can send out the finished product of the defined wheel rim.

The movable clamp device 7 is a robotic arm to sequentially clamp and move wheel rim blanks at the clamping position to the first processing device 3, the second processing device 4, and the third processing device 5, then clamp and move the finished product of defined wheel rims from the third processing device 5 to the discharge device 6.

The controlling device 8 respectively electrically connects to the infeed device 1, the detecting device 2, the first processing device 3, the second processing device 4, the third processing device 5, the discharge device 6, and the movable clamp device 7 to control the actuations of each of the devices; as the controlling device 8 receives a detection signal sent from the detecting device 2, the controlling device 8 is able to control the first processing device 3, the second processing device 4, and the third processing device 5 to conduct particular processes corresponding to the detection signal received from the wheel rim blank.

The position setting of each of the devices of the wheel rim processing machine of the present invention is circular, wherein the movable clamp device 7 is put at the center, and surrounding the moveable clamp device 7 in a clockwise manner are, in order, the infeed device 1, the detecting device 2, the first processing device 3, the second processing device 4, the third processing device 5, and the discharge device 6, while the controlling device 8 may be set at a place based on the need for the controlling device 8.

The actual processing process mainly includes having the infeed device 1 deliver a wheel rim blank to a clamping position, having the detecting device 2 applying light sensoring to detect the size and shape of the wheel rim blank and send out a detection signal corresponding to the wheel rim blank to the controlling device 8, and having the controlling device 8 compare the detection signal to the preloaded information in the controlling device 8, and to send corresponding messages respectively to the first processing device 3, the second processing device 4, the third processing device 5, and the movable clamp device 7, so as to let each device proceed to apply a process in response to different wheel rim blanks. As the wheel rim blank is processed by the first processing device 3, the movable clamp device 7 will clamp and move the wheel rim blank to the second processing device 4 after the first processing device 1 completes its process; as the wheel rim blank is processed by the second processing device 4, the movable clamp device 7 will clamp and move the wheel rim blank to the third processing device 5 after the second processing device 4 completes its process; as the third processing device finishes the process, the movable clamp device 7 will clamp and move the finished product of a defined wheel rim after the third processing device 5 completes its process to the discharge device 6 to be sent out.

As the wheel rim processing machine of the present invention is going to process wheel rim blanks with various sizes and shapes, it does not have to be shutdown and reset, but directly proceeds to the respective process for any of a number of specifications of a defined wheel rim through the automatic control of the controlling device 8. In other words, as wheel rim blanks with various sizes and shapes are sequentially processed, the first processing device 3, the second processing device 4, the third processing device 5, and the movable clamp device 7 will respectively receive different signals from the controlling device 8 to change their process patterns, so that the processing devices may independently work on several wheel rim blanks at the same time, so as to produce finished products with different sizes and shapes. Therefore, the wheel rim processing machine of the present invention is efficient and can save time and money by producing various defined wheel rims at a much faster pace.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. a wheel rim processing machine for processing a wheel rim blank into a finished product of a defined wheel rim, comprising:
an infeed device to deliver a wheel rim blank to a clamping position;
a detecting device to detect the size and shape of said wheel rim blank located at said clamping position, and to send out a corresponding detection signal;
a first processing device to process a radial dimension of a top portion of said wheel rim blank;
a second processing device to bore on a side of said wheel rim blank;
a third processing device to process a radial dimension of a bottom portion and a side of said wheel rim blank, so as to make said wheel rim blank into said finished product of said defined wheel rim;
a discharge device to send out said finished product of said wheel rim;
a movable clamp device to sequentially clamp and move each of said wheel rim blanks to a clamping position at said first processing device, at said second processing device, and at said third processing device, then clamp and move the finished product of said defined wheel rim finished by said third processing device to said discharge device; and
a controlling device respectively electrically connecting to said infeed device, said detecting device, said first processing device, said second processing device, said third processing device, said discharge device, and said movable clamp device to control actuations of each of said device; and once said controlling device receives said detection signal sent by said detecting device, said controlling device can automatically control said first processing device, said second processing device, and said third processing device to conduct specific processes, according to said detection signal, to said wheel rim blank.
